(19) United States
(12) Patent Application Publication
(10) Pub. No.: US 2025/0114265 A1
(43) Pub. Date: Apr. 10, 2025

(54) KNEE DECOMPRESSION ASSEMBLY AND METHOD FOR KNEE DECOMPRESSING

(71) Applicant: North American Medical Corporation, Marietta, GA (US)

(72) Inventors: Gidgette Becerra Rubin, Atlanta, GA (US); Larry Rubin, Atlanta, GA (US); Carlos Mario DeCarro

(21) Appl. No.: 18/484,274

(22) Filed: Oct. 10, 2023

(51) Int. Cl. A61H 1/02

(52) U.S. Cl. CPC A61H 1/0218; A61H 1/024; A61H 2201/10; A61H 2201/1642; A61H 2201/1676; A61H 2203/0431

(57) ABSTRACT

A knee decompression assembly and a method of decompressing a knee or knees is provided herein. The assembly has a seat and an upper leg holder configured and disposed to hold an upper leg of a patient on the seat, a lower leg support and a lower leg holder configured and disposed to hold a lower leg of the patient on the lower leg support, and a tensioner configured and disposed for moving the lower leg holder or seat away from the other and providing a desired tension force about the patient's knee(s). The lower leg holder or seat may be configured and disposed to tilt and provide a desired angle between the seat and the lower leg support and about the patient's knee(s) or be configured to treat both of the patients knees simultaneously, or both.

### FIELD OF THE DISCLOSURE

The present disclosure relates to a knee decompression assembly and method for knee decompressing.

### BACKGROUND

In decompression knee therapy, the knee joint is tensioned in a manner that may provide more joint space, an increase of fluids into the join cavity or a rehydration of worn and damaged tissue. In particular, traction may be defined as the separation of joint surfaces. Decompression knee therapy may be characterized as the separation of joint surfaces which may aid in increasing ranges of motion or flexion, or address muscle guarding, ligament laxity, or degenerative osteoarthritis.

Some existing decompression therapies involve simply jerking on the knee, ankle, or leg, hooking the knee or leg up to some form of pulling device as may be found on some traction and decompression devices, or static traction with bags of sand or water. These existing decompression assemblies may not provide the desired results. There is, thus, a need in the art for a knee decompression assembly that offers comfort and safety for the patient and provides a variety of operational parameters or a controlled application of tension about the patient's knee or knees.

### SUMMARY

In one aspect of the present disclosure, a knee decompression assembly is provided. The knee decompression assembly has a seat and an upper leg holder configured and disposed to hold an upper leg of a patient on the seat. A lower leg support is configured to support a lower leg and a lower leg holder is configured and disposed to hold a lower leg of the patient on the lower leg support. A tensioner is configured and disposed for a movement of at least one of the lower leg support and the seat away from the other and to provide a desired tension force about the patient's knee. At least one of the lower leg support and the seat is configured and disposed to tilt and provide a desired angle between the seat and the lower leg support and about the patient's knee.

In another aspect of the present disclosure, a method of decompressing a knee is provided. The method comprises the steps of: sitting a patient on a seat; holding an upper leg of the patient on the seat; holding a lower leg of the patient on a lower leg support; tilting at least one of the lower leg support and the seat and providing a desired angle between the seat and the lower leg support and about the patient's knee; and moving at least one of the lower leg support and the seat away from the other and providing a desired tension force between the patient's upper leg and lower leg and about the patient's knee.

In a further aspect, a knee decompression assembly has a seat and an upper leg holder configured and disposed to hold an upper right leg and an upper left leg of a patient on the seat. The assembly has a lower leg support and a lower leg holder, wherein the lower leg holder is configured and disposed to hold a lower right leg and a lower left leg of the patient on the lower leg support. A tensioner is configured and disposed for a movement of at least one of the lower leg support and the seat away from the other and for providing a desired tension force about the patient's knees.

### BRIEF DESCRIPTIONS OF THE DRAWINGS

The foregoing and other features of this disclosure will become more fully apparent from the following description and appended claims, taken in conjunction with the accompanying drawings and examples. Understanding that these drawings depict only several embodiments in accordance with the disclosure and are, therefore, not to be considered limiting of its scope. The disclosure will be described with additional specificity and detail through use of the accompanying drawings, in which:

FIG. 1 shows an illustrative example of the knee decompression assembly of the present disclosure;

FIG. 2 shows the illustrative example of knee decompression of the present disclosure having operational parameters adjusted; and

FIG. 3 shows a top view of the illustrative example of the knee decompression assembly of the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

Presently disclosed is a knee decompression assembly and method of decompressing knee(s). The assembly may, or may not, be powered and is configured to provide a form of controlled traction, or tension, that may open the knee joint or joints. For example, opening the knee joint(s) up to a few millimeters, may allow an increase in delivery of fluid and nutrients into the knee joint or joints.

In one embodiment, a patient may sit on a seat and one or hold one or both upper legs may be secured or held on the seat. The patient may place one or both lower legs on a lower leg support and be held or secured thereon. The seat and the lower leg support are then separated from each other, providing tension about the knee joint(s) and decompress the knee(s). In some cases, only one knee may be desired to be treated, and in other cases, both knees may be treated simultaneously or individually.

In at least one embodiment, the knee decompressing assembly has a padded or cushioned top surface upon which the patient may sit and lay his or her leg or legs. A lower leg holder, such as a stabilizing strap, may be used to hold, secure, or stabilize the lower part of the patient's leg or legs on a lower leg support. The upper legs or leg to be treated are stabilized or held on the on the seat with an upper leg holder, such as a stabilizing strap or other like device. Specifically, the holding or immobilization of the upper leg or legs and a movement of the lower leg or legs apart from each other produce tension about the knee(s) or a decompression effect.

The assembly may have padded top portions for supporting the patient. The decompressing assembly is configured to may move the upper surfaces of the seat and lower leg support apart from each other in a linear or angular direction, with the patient's leg or legs (upper and lower leg) held or stabilized. A tensioner may be configured and disposed for a movement of at least one of the lower leg support and the seat away from the other and provide a desired tension force about the patient's knee. For example, a tensioning device, such as an actuator, may be configured and disposed to move the seat and lower leg support apart.

In at least one embodiment of the presently disclosed knee decompression assembly, the assembly may be used to assist patients that have acute or chronic knee conditions. The assembly distracts or tensions the knee gently and precisely based on the patient's problem(s) or condition(s). Decompression of the knee has been shown open up the joint spaces which have narrowed under time and stress. The assembly may also help realign the knee joint itself as well as to strengthen muscles and connective tissue. Knee decompression may also reduce inflammation which may provide pain relief while reducing swelling. Knee decompression may also allow the knees to rehydrate which may be important to recovery as well to help with unwanted muscle contractions. The assembly may also provide increased distraction, ranges of motion, or pain relief.

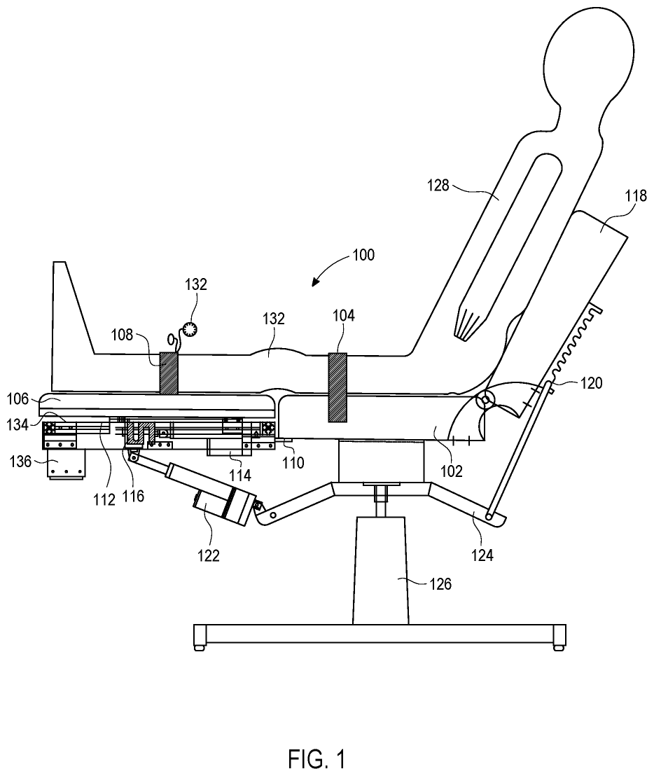

FIGS. 1-3 show an illustrative example of knee decompression assembly 100. FIG. 1 is a side view of knee decompression assembly 100 having patient 128 with their right and left leg linearly extending on seat 102 and onto lower leg support 106. Knee decompression assembly 100 has a seat 102 and an upper leg holder 104 configured and disposed to hold an upper leg, or both upper legs, of patient 128 on seat 102. Lower leg support 106 is configured and disposed to support the lower legs of patient 128. Lower leg holder 108 is configured and disposed to hold a lower leg, or both lower legs, of patient on lower leg support 106. For example, upper leg holder 104 and lower leg holder 108 may be configured and disposed to hold one leg or both legs for decompression of one or both knees 130.

Tensioner 114 is configured and disposed for a movement of at least one of lower leg support 106 and seat 102 away from the other and provide a desired tension force about the patient's knee or knees 130. For example, a distance 107 between the seat 102 and lower leg support 106 may be increased to provide a desired tension about knee or knees 130. In at least one embodiment, at least one of lower leg support 106 and seat 102 may be configured and disposed to tilt and provide a desired angle α between seat 102 and lower leg support 106, and about patient's 128 knee(s) 130. Upper leg holders 104 and lower leg holders 108 may be configured and disposed to hold one leg or both legs for decompression of one or both knees.

In at least one other embodiment, knee decompression assembly 100 is configured to treat both of the patient's knees simultaneously. For example, seat 102 and upper leg holder 104 may be configured and disposed to hold both upper legs of patient 128 on seat 102. Lower leg support 106 is configured and disposed to support both lower legs of patient 128 and lower leg holder 108 is configured and disposed to hold both lower legs, of patient 128 on lower leg support 106. In this embodiment, knee decompression assembly 100 may, or may not, be configured and disposed to tilt and provide an angle α between seat 102 and lower leg support 106. For example, knee decompression assembly 100 having patient 128 with their right and left leg linearly extending on seat 102 and onto lower leg support 106, as shown in FIG. 1, may be maintained during treatment or tensioning about the knees.

In at least one embodiment of knee decompression assembly 100, slide rail 112 hingedly extends from the seat 102, with hinge 110. At least one bracket 134 depends from lower leg support 106 and slidingly engages slide rail 112. The at least one bracket 134 and slide rail 112 are configured and disposed for guiding a sliding movement of lower leg support 106 away from seat 102 and provide a desired distance 107 or desired tension force about patient's 128 knee or knees 130.

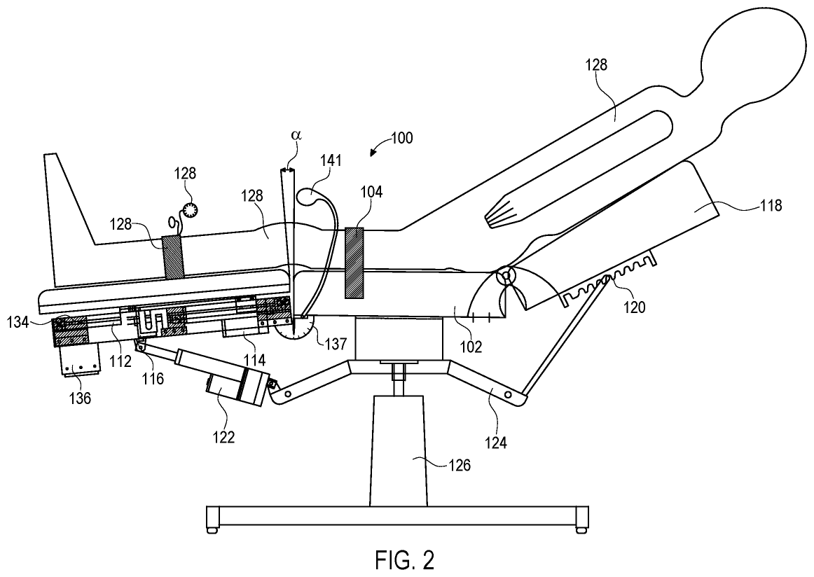

In at least one other embodiment, at least one hinge 110 extends from seat 102 and engages slide rail 112. At least one of lower leg support 106 and seat 102 is configured and disposed to rotate about the at least one hinge 110 and provide the tilt at the desired angle α between seat 102 and lower leg support 106, as shown in FIG. 2. In at least one embodiment, angle measuring device 137 is configured and disposed to measure angle α.

Tensioner 114 is configured and disposed for a movement of at least one of the lower leg support 106 and seat 102 away from each other and provide a desired tension force about knee or knees 130. Tensioner 114 may comprise a tensioning device configured and disposed slidingly move lower leg support 106 away from seat 102, along slide rail 112. For example, a tensioning device may have an actuator or be manually or power driven. In at least one embodiment, a load cell 116 is configured and disposed to measure a tension force about knee or knees 130.

In at least one embodiment, knee decompression assembly 100 has a tilting device 122 configured and disposed to tilt at least one of lower leg support 106 and seat 102 and provide the desired angle α between seat 102 and lower leg support 106 and about patient's 128 knee or knees 130.

Knee decompression assembly 100 may have a seatback 118 configured and disposed to support a back of patient 128 resting on seat 102. Reclining and inclining device 120 may be configured and disposed to recline, incline, and hold seatback 118 at a desired angle.

In at least one embodiment, knee decompression assembly 100 has a support arm 124 configured and disposed to support seat 102 and lower leg support 106. For example, support arm 124 may extend from a stand 126, which may be height adjustable, and provide support for seat 102 and lower leg support 106. In at least one embodiment, tilting device 122 extends from support arm 124 and engages lower leg support 106. For example, tilting device 122 may cooperate with slide rail 112. In at least one other embodiment, reclining and inclining device 120 extends from support arm 124 to support seatback 118.

In at least one embodiment, knee decompression assembly 100 is configured and disposed to delivery red light therapy, with red light therapy device 141 for example. Red light therapy device 141 may be disposed with one or both upper leg holders 104 or have one or two light delivering end portions extending from knee decompression assembly 100, such as a light delivering end portions extending from seat 102 with an articulating arm. Red light therapy, also known as low-level laser therapy (LLLT) or photobiomodulation (PBM), is a non-invasive form of treatment that uses low-level red or near-infrared light to stimulate cellular activity. For example, light in the range of between about 630 nm and 880 nm may be directed to the area being treated. This therapy may stimulate mitochaondria, increase blood circulation, and increase blood circulation, manage pain related to various conditions such as arthritis, joint disorders, or muscle strains. For example, red light therapy may be used help reduce pain and inflammation about the knee or knees and promote healing.

FIG. 2 shows knee decompression assembly 100 having operational parameters adjusted. For example, knee decompression assembly 100 may be configured and disposed to tilt at least one of lower leg support 106 and seat 102 and provide the desired angle α between seat 102 and lower leg support 106 and about patient's 128 knee or knees 130. Tilting device 122 may have an actuator or be manually or power driven to provide a desired angle α between seat 102 and lower leg support 106 and to hold the desired angle α between seat 102 and lower leg support 106. Angle α may between 0° and 90°. The desired angle α may be altered or changed during a treatment process or protocol to provide a desired decompression therapy.

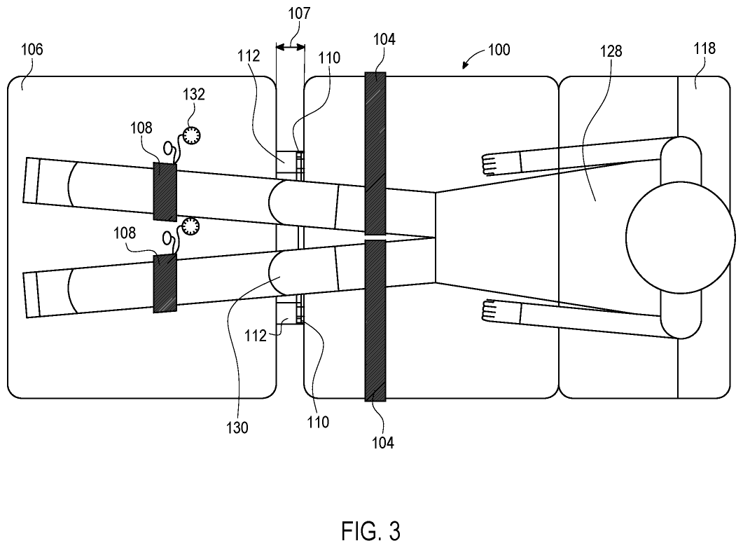

FIG. 3 shows a top view of the illustrative example of knee decompression assembly of 100. Knee decompression assembly 100 shows patient 128 with their right and left leg on seat 102 and lower leg support 106. Knee decompression assembly 100 has a seat 102 and an upper leg holder 104 configured and disposed to hold an upper leg, or both upper legs, of patient 128 on seat 102. For example, upper leg holder 104 may be configured to individually hold patient's 128 upper legs on seat 102. In this embodiment, one or both of patient's 128 upper legs may be held on seat 102 for providing tension about one or both knees 130, as may be desired.

Lower leg support 106 is configured and disposed to support the lower legs of patient 128. Lower leg holder 108 is configured and disposed to hold a lower leg, or both lower legs, of patient 128 on lower leg support 106. For example, lower leg holder 108 may be configured to individually hold patient's 128 lower legs on lower leg support 106. In this embodiment, one or both of patient's 128 lower legs may be held on lower leg support 106 for providing tension about one or both knees 130, as may be desired.

One or both of upper leg holders 104 and lower leg holders 108 may be adjustable and repositionable in order to accommodate and hold or stabilize differently sized legs. For example, upper leg holders 104 and lower leg holders 108 may have a device or strap that may be lengthwise adjustable, for example, via one or more fasteners, in order to form a loop or a partial loop of different sizes and/or circumferences. In at least one embodiment, one or both of upper leg holders 104 and lower leg holders 108 have a strap and connector, such as a hook and loop type fastener (e.g., VELCRO™), which allows the leg holders to be configured or formed into a loop of a selected size or circumference. Other fasteners may be used to allow for a length-wise adjustable strap or cuff, including, but in no way limited to buttons, snaps, hooks, loops, clips, clamps, etc. Another feature of at least one embodiment of the upper or lower leg holders may include the ability to adjust the interior circumference of the loop formed thereby or otherwise create a compression force upon the leg through an internal air bladder. In at least one embodiment, one or both of upper leg holders 104 and lower leg holders 108 include a bladder which may be inflated and/or deflated, as desired. A readout pressure gauge 132 may also be provided to measure the pressure or force within the air bladder. while the stabilizing device

Knee decompression assembly 100 may comprise structures or apparatuses, such as, a reclining or lounge type chair, ergonomic chair, bed or platform, etc. In at least one embodiment, seat 102 and/or lower leg support 106 may have padded cushions or other like surface(s) upon which the user or patient may be seated. In at least one embodiment, lower leg support 106, seat 102, and seatback 118 are padded. For example, pads or cushions may be disposed to support patient 128 on knee decompression assembly 100. The pads or cushions may comprise a vinyl antimicrobial material or other materials. Various embodiments of knee decompression assembly 100 are configured to support the patient or user in a generally or substantially still, stationery or immobile position during treatment of the knee(s). For example, knee decompression assembly 100 may provide a lounge-type chair, dentist's chair, barber chair, bench, bed, doctor's office patient bed, S-bed, cot, examination table/bed, and the like.

In at least one embodiment, knee decompression assembly 100 is configured to treat both knees 130 simultaneously. For example, the upper leg holder 104 and the lower leg holder 108 may be configured and disposed to hold patient's 128 right and left upper leg on seat 102 and their right and the left lower leg on lower leg support 106.

In at least one other embodiment of the present disclosure, knee decompression assembly 100 is configured for at least one of 1) treating both knees 130 simultaneously and 2) tilting at least one of lower leg support 106 and seat 102 to provide a desired angle α between seat 102 and lower leg support 106.

A method of decompressing a knee is presently disclosed. A patient sits on a seat and at least one of their upper legs is held on the seat. One or both of the patient's lower legs are held on a lower leg support. At least one of the lower leg support and the seat is tilted to provide a desired angle between the seat and the lower leg support and about the patient's knee. At least one of the lower leg support and the seat are moved away from the other to provide a desired tension force between the patient's upper leg and lower leg and about the patient's knee.

The moving of the at least one of the lower leg support and the seat may comprise activating a tensioner. The tension force about the patient's knee created with the separation of the seat and lower leg support may be measured. The tilting of at least one of the lower leg support and the seat may comprise activating a pivoting device. The angle between the seat and the lower leg support may be measured. The patient's back may be supported on a seatback and the seatback may be inclined or reclined to support the patient's back at a desired angle. In at least one embodiment, red light therapy is delivered to at least one of the patient's knees.

Knee decompression assembly 100 may be configured for manual or powered treatment. In at least one embodiment, knee decompression assembly 100 provides a form of controlled traction that opens up the knee joint, for example, by one to several millimeters, for a desired period of time. A treatment protocol or pattern may be performed through the use of one or more preprogramed and designed treatment patterns and protocols. For example, a treatment protocol or pattern may provide for one or more of: adjusting desired angle α between seat 102 and lower leg support 106; providing a desired tension force about the patient's knees; treating or tensioning for a time increment; relaxing the tension; readjusting the angle α or the tension force; and treating or tensioning for subsequent time increment(s). A variety of treatment protocols or patterns may be provided with the presently disclosed knee decompression assembly. For example, control box 136 may be configured and disposed to receive commands for controlling tensioner 114 and tilting device 122.

1. A knee decompression assembly, comprising:
a seat;
an upper leg holder configured and disposed to hold an upper leg of a patient on the seat;
a lower leg support;
a lower leg holder configured and disposed to hold a lower leg of the patient on the lower leg support;
a tensioner configured and disposed for a movement of at least one of the lower leg support and the seat away from the other and providing a desired tension force about the patient's knee;
wherein at least one of the lower leg support and the seat is configured and disposed to tilt and provide a desired angle between the seat and the lower leg support and about the patient's knee.

2. The knee decompression assembly of claim 1, further comprising:
a slide rail hingedly extending from the seat;
at least one bracket depending from the lower leg support and slidingly engaging the slide rail;
wherein the at least one bracket and slide rail are configured and disposed for guiding a sliding movement of the lower leg support away from the seat and providing the desired tension force about the patient's knee;
at least one hinge extending from the seat and engaging the slide rail; and
wherein at least one of the lower leg support and the seat is configured and disposed to rotate about the at least one hinge and provide the tilt at the desired angle between the seat and the lower leg support, about the patient's knee.

3. The knee decompression assembly of claim 2, wherein the tensioner comprises a tensioning device configured and disposed slidingly move the lower leg support away from the seat.

4. The knee decompression assembly of claim 1, further comprising a tilting device configured and disposed to tilt the at least one of the lower leg support and the seat and provide the desired angle between the seat and the lower leg support and about the patient's knee.

5. The knee decompression assembly of claim 1, further comprising a load cell configured and disposed to measure the tension force about the knee.

6. The knee decompression assembly of claim 1, further comprising a seatback configured and disposed to support a back of the patient resting on the seat.

7. The knee decompression assembly of claim 6, further comprising a reclining and inclining device configured and disposed to recline, incline, and hold the seatback at a desired angle.

8. The knee decompression assembly of claim 1, further comprising a support arm configured and disposed to support the seat and the lower leg support.

9. The knee decompression assembly of claim 1, wherein the upper leg holder and the lower leg holder are configured and disposed to hold the patient's right and left upper leg on the seat and the right and the left lower leg on the lower leg support.

10. A method of decompressing a knee, comprising the steps of:
sitting a patient on a seat;
holding an upper leg of the patient on the seat;
holding a lower leg of the patient on a lower leg support;
tilting at least one of the lower leg support and the seat and providing a desired angle between the seat and the lower leg support and about the patient's knee; and
moving at least one of the lower leg support and the seat away from the other and providing a desired tension force between the patient's upper leg and lower leg and about the patient's knee.

11. The method of claim 10, wherein the step of moving the at least one of the lower leg support and the seat comprises activating a tensioner.

12. The method of claim 10, wherein the step of tilting at least one of the lower leg support and the seat comprises activating a pivoting device.

13. The method of claim 10, further comprising a step of delivering red light therapy to at least one of the patient's knees.

14. The method of claim 10, further comprising a step of supporting a back of the patient sitting on the seat.

15. The method of claim 14, further comprising a step of reclining or inclining and supporting the back of the patient at a desired angle.

16. The method of claim 10, wherein the steps of holding the patient's upper leg on the seat and holding the patient's lower leg on the lower leg support comprise holding the patient's right and left upper legs on the seat and holding the patient's right and left lower legs on the lower leg support.

17. A knee decompression assembly, comprising:
a seat;
an upper leg holder configured and disposed to hold an upper right leg and an upper left leg of a patient on the seat;
a lower leg support;
a lower leg holder configured and disposed to hold a lower right leg and a lower left leg of the patient on the lower leg support;
a tensioner configured and disposed for a movement of at least one of the lower leg support and the seat away from the other and providing a desired tension force about the patient's knees.

18. The knee decompression assembly of claim 17, further comprising:
a slide rail hingedly extending from the seat;
at least one bracket depending from the lower leg support and slidingly engaging the slide rail; and
wherein the at least one bracket and slide rail are configured and disposed for guiding the movement of the lower leg support away from the seat and providing the desired tension force about the patient's knees.

19. The knee decompression assembly of claim 17, further comprising at least one or a load cell configured and disposed to measure the tension force about the knees and one or two red light therapy devices.

20. The knee decompression assembly of claim 18, further comprising:
at least one hinge extending from the seat and engaging the slide rail; and
wherein at least one of the lower leg support and the seat is configured and disposed to rotate about the at least one hinge and provide a tilt at a desired angle between the seat and the lower leg support and about the patient's knees.
